(19) United States
(12) Patent Application Publication
(10) Pub. No.: US 2025/0163874 A1
(43) Pub. Date: May 22, 2025

(54) FUEL INJECTION THROTTLE BODY

(71) Applicant: Holley Performance Products, Inc., Bowling Green, KY (US)

(72) Inventors: Doug Flynn, Bowling Green, KY (US); James Dralle, Bowling Green, KY (US); Amy Gieske, Loogootee, IN (US); Charles Jenckes, Harrisburg, NC (US); Corey Spainhoward, Bowling Green, KY (US)

(21) Appl. No.: 19/029,807

(22) Filed: Jan. 17, 2025

Related U.S. Application Data
(63) Continuation of application No. 17/882,762, filed on Aug. 8, 2022, now Pat. No. 12,203,434.
Application No. 17/882,762 is a continuation of application No. 16/778,341, filed on Jan. 31, 2020, now Pat. No. 11,409,894.
Application No. 16/778,341 is a continuation of application No. 15/986,571, filed on May 22, 2018, now Pat. No. 10,570,866.
Application No. 15/986,571 is a division of application No. 14/156,813, filed on Jan. 16, 2014, now Pat. No. 10,012,197.
(60) Provisional application No. 61/892,706, filed on Oct. 18, 2013.

(51) Int. Cl. F02M 61/18; B05B 1/14; F02D 9/10; F02M 7/06; F02M 35/10; F02M 35/12; F02M 69/04; G06F 16/22; G06F 21/62

(52) U.S. Cl. CPC F02M 61/1826; B05B 1/14; F02D 9/1035; F02M 7/06; F02M 35/10216; F02M 35/1216; F02M 61/184; F02M 69/043; G06F 16/2282; G06F 21/6218; G06F 21/6227; F02D 9/109

(57) ABSTRACT

A method of using a throttle body fuel injection system including a throttle body with at least one air intake, an electronic fuel injector coupled to the throttle body at a fuel port and an annular ring coupled to the cylindrical inner wall of the air intake. The annular ring includes a fuel discharge orifices arranged radially around the annular ring for spraying atomized fuel into the air intake, in order to operate an internal combustion engine.

### INCORPORATION BY REFERENCE

Any and all applications for which a foreign or domestic priority claim is identified in the Application Data Sheet as filed with the present application are hereby incorporated by reference herein and made a part of the present disclosure.

### BACKGROUND OF THE INVENTION

Throttle Body Fuel Injection (“TBI”) is a type of Electronic Fuel Injection (“EFI”) for internal combustion engines that became main stream in factory vehicles during the 1980's. TBI Fuel Injection consists of an air metering valve that contains fuel injectors. The air metering valve allows more airflow as driver depresses gas pedal. The fuel injectors add fuel as a function of airflow. The TBI is controlled by an Electronic Control Unit (“ECU”).

Factory car producers moved away from this type of fuel injection as government emissions standards increased in the mid-to-late 1980's. However, the aftermarket automotive parts industry started selling aftermarket TBI fuel injection systems in the late 1980's. These systems were designed to replace the carburetor on older carbureted vehicles from the 1960's to 1980's.

One of the limitations of many aftermarket fuel injection systems is that the end consumer has to have a significant level of knowledge on tuning the ECU that controlled these systems. Recently, technology has advanced and several companies now offer systems that are “self-tuning”, where the end consumer only has to perform basic installation, and the ECU monitors various sensors and automatically tunes itself. This has caused resurgence in people purchasing TBI systems to retrofit older carbureted vehicles. The main benefit of TBI fuel injection is the fact that it can be retrofit fairly easy on older carbureted vehicles, on many different applications, as compared to other types of fuel injection methods such as Multiport EFI, which requires replacement of a multitude of original engine components.

Factory TBI system designs utilized fuel injectors that sprayed fuel at higher pressure that were placed vertically above the throttle plates of the throttle body. Mostly due to aesthetics, and available fuel injector designs, most aftermarket TBI systems place fuel injectors horizontally (or close to a horizontal position) into the sides of the throttle body. Unlike the factory TBI designs, this horizontal placement requires a throttle body design that redirects the normal fuel injector spray pattern. If fuel is not directed into the throttle body in a way that atomizes the fuel so it can thoroughly mix with the airstream through the throttle body, the engine may not run smoothly, may not make adequate power, and may have poor fuel economy and emissions.

### SUMMARY OF THE INVENTION

In order to overcome the limitations of current aftermarket TBI designs, embodiments of this invention are such, that a conventional high pressure electronically controlled fuel injector sprays into a chamber that is constrained by an annular fuel distribution ring. The annular fuel distribution ring may contain at least one radial channel and orifices coupled to the channel. The orifices allow the fuel to exit into the air stream from several positions around the circumference of an air intake in the throttle body, allowing the fuel to mix with the air and enter the engine in an optimally atomized state.

### BRIEF DESCRIPTION OF THE DRAWINGS

FIG. 1 is a front plan view of a throttle body with annular fuel injection according to an embodiment of the invention.

FIG. 2 is cross-section view A-A of the throttle body of FIG. 1.

FIG. 3 is detail view C of the throttle body of FIG. 2.

FIG. 4 is cross-section view B-B of the throttle body of FIG. 1.

FIG. 5 is detail view D of the throttle body of FIG. 4.

FIG. 6 is an isometric bottom view of a throttle body with annular fuel injection according to an embodiment of the invention.

FIG. 7 is detail view E of the throttle body of FIG. 6.

FIG. 8 is an isometric top view of the annular ring element according to an embodiment of the invention.

FIG. 9 is a schematic isometric view showing the fuel injection and air flow according to an embodiment of the invention.

### DETAILED DESCRIPTION OF THE PREFERRED EMBODIMENTS

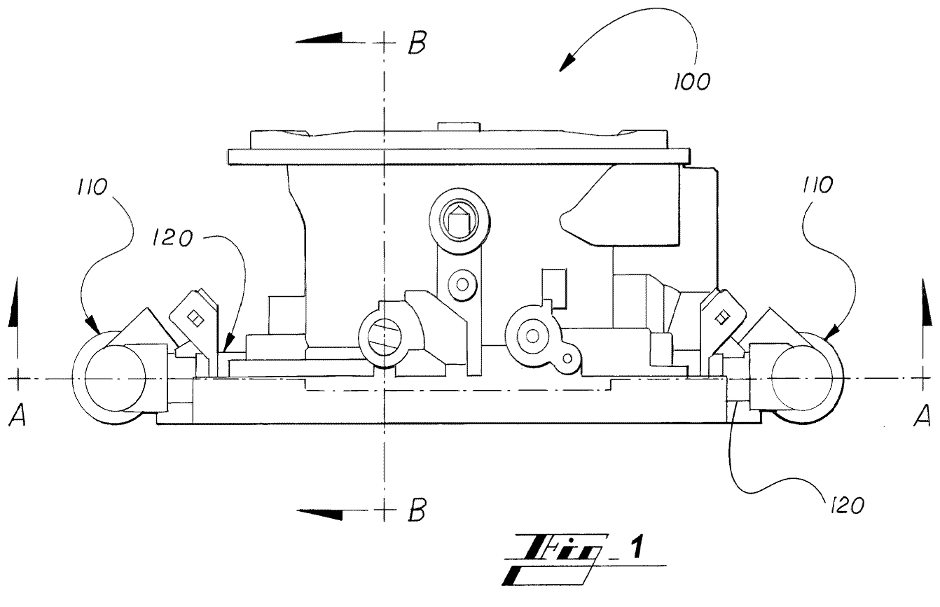

Shown in FIG. 1 is an embodiment of a throttle body 100 having fuel rails 110 aligned horizontally near the bottom surface of the throttle body 100. The fuel rails 110 provide pressurized fuel to the fuel injectors 120, which couple to the throttle body 100 at fuel ports 210 (not shown). In some embodiments the fuel injectors 120 may be aligned horizontally in respect to the throttle body 100. In other embodiments the fuel injectors 120 may be aligned at an angle above or below horizontal in respect to the throttle body 100.

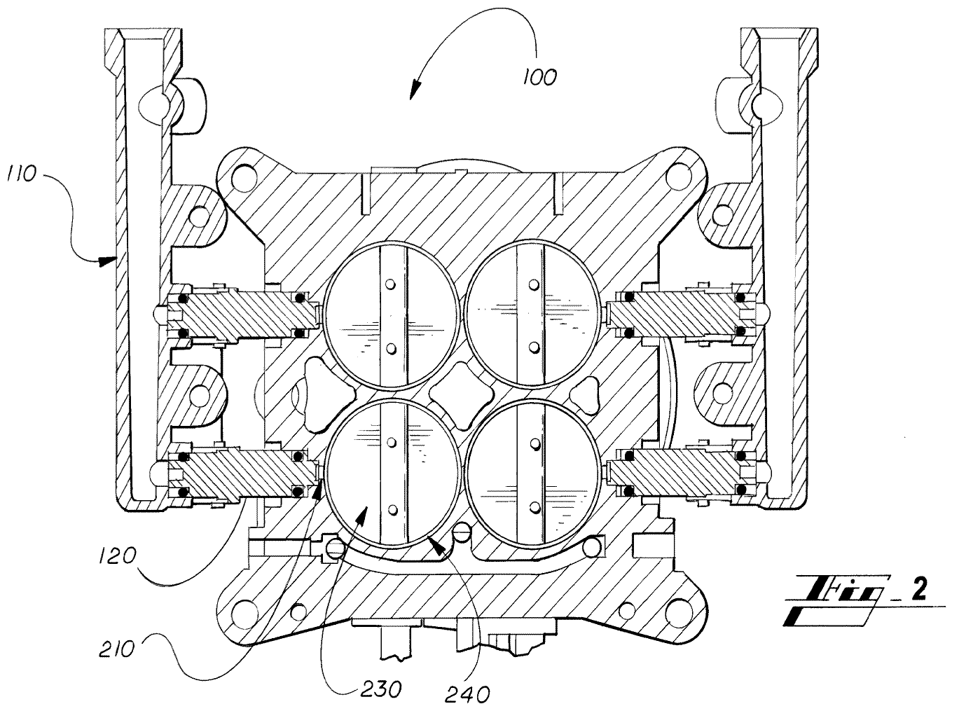

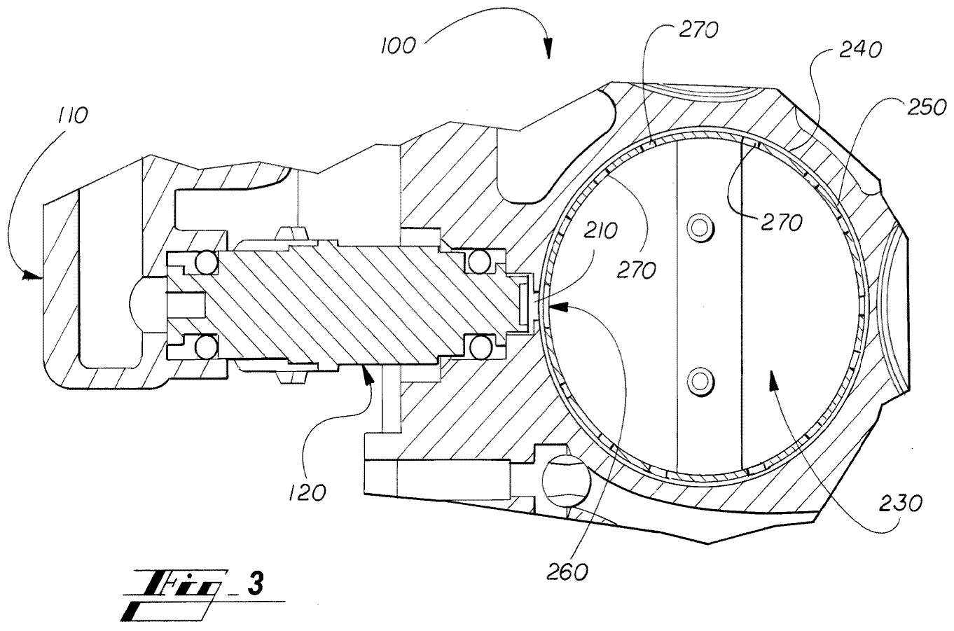

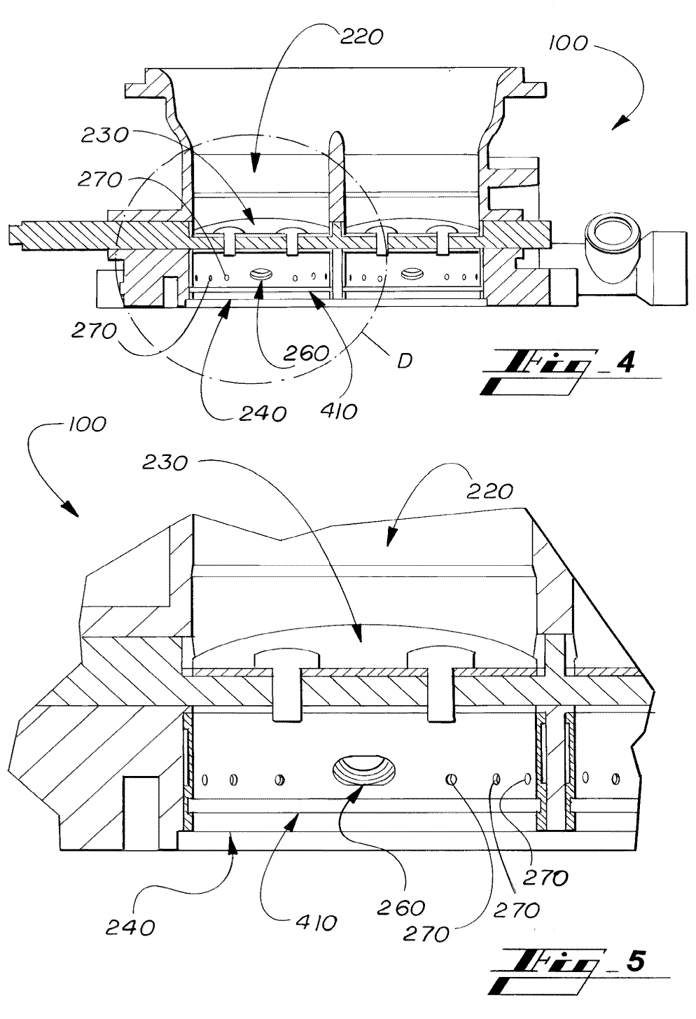

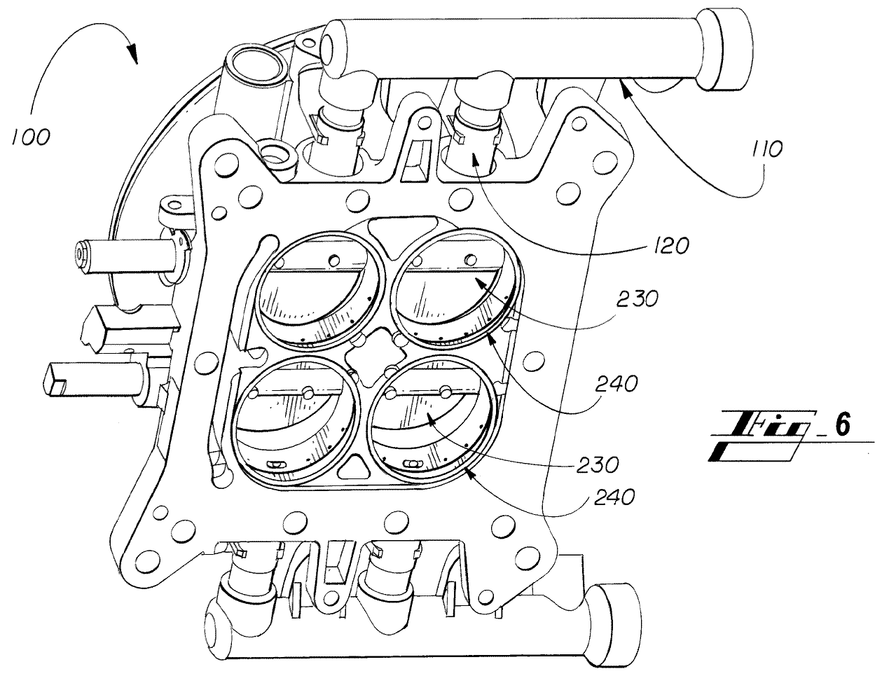

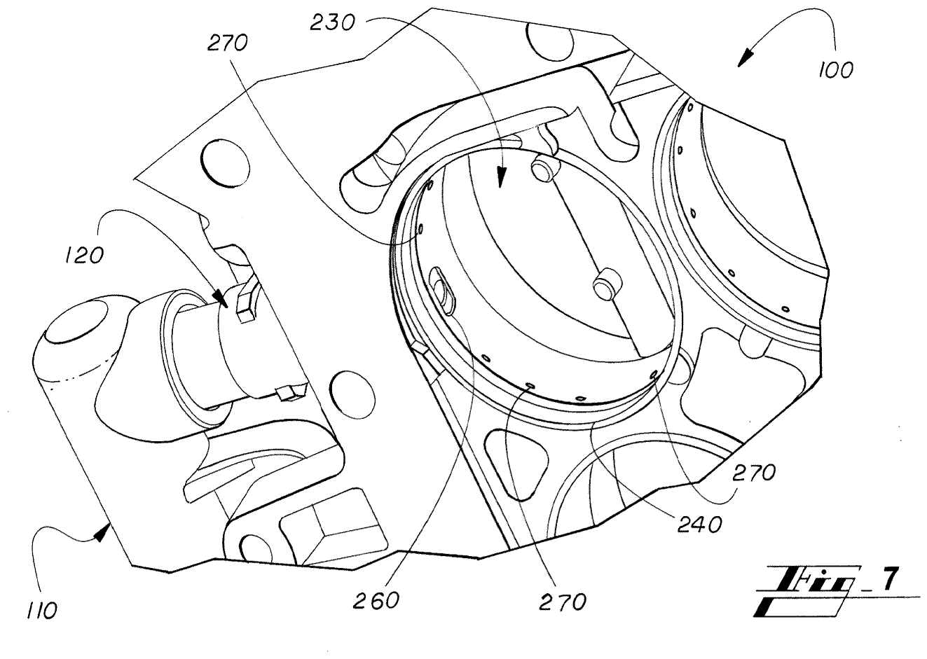

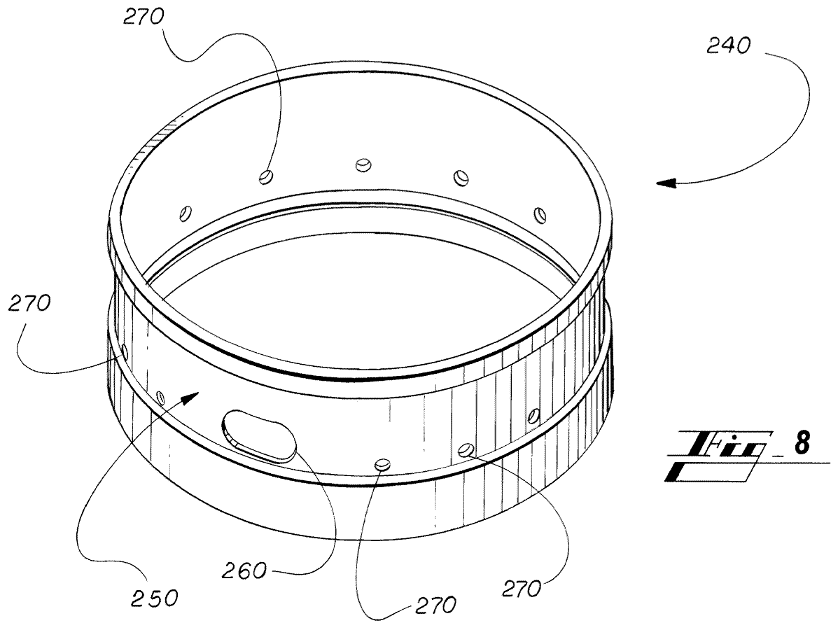

As shown in FIGS. 2-7, each fuel rail 110 may be coupled to one or more fuel injectors 120. Each fuel injector 120 provides fuel through a fuel port 210 into an annular ring 240 positioned in an air intake 220 of the throttle body 100 below the throttle plate 230. The annular ring 240 includes an annular fuel channel 250 for distributing fuel around the annular ring 240 to a plurality of fuel discharge orifices 260 and 270. The plurality of fuel discharge orifices 260 and 270 are configured to atomize and spray the fuel into the air intake 220 from multiple directions.

In some embodiments there may be a larger primary fuel discharge orifice 260 aligned in front of the fuel port 210 along with a plurality of smaller secondary fuel discharge orifices 270 aligned radially around the annular ring 240. In various embodiments the secondary fuel discharge orifices 270 may vary in size and shape as desired. In some embodiments the fuel discharge orifices 260 and 270 may be of circular, ovular, elliptical, and/or polygonal shapes.

In one embodiment the primary fuel discharge orifice 260 may be a 0.25 inch diameter circular orifice. In other embodiments the primary fuel discharge orifice 260 may be a 0.28 to 0.40 inch wide by 0.155 ovular-slot orifice.

In one embodiment the secondary fuel discharge orifices 270 may be 0.047 to 0.100 inch diameter circular orifices. The secondary fuel discharge orifices 270 may be spaced radially around the annular ring 240 at angular separations of 20 to 38 degrees from adjacent orifices.

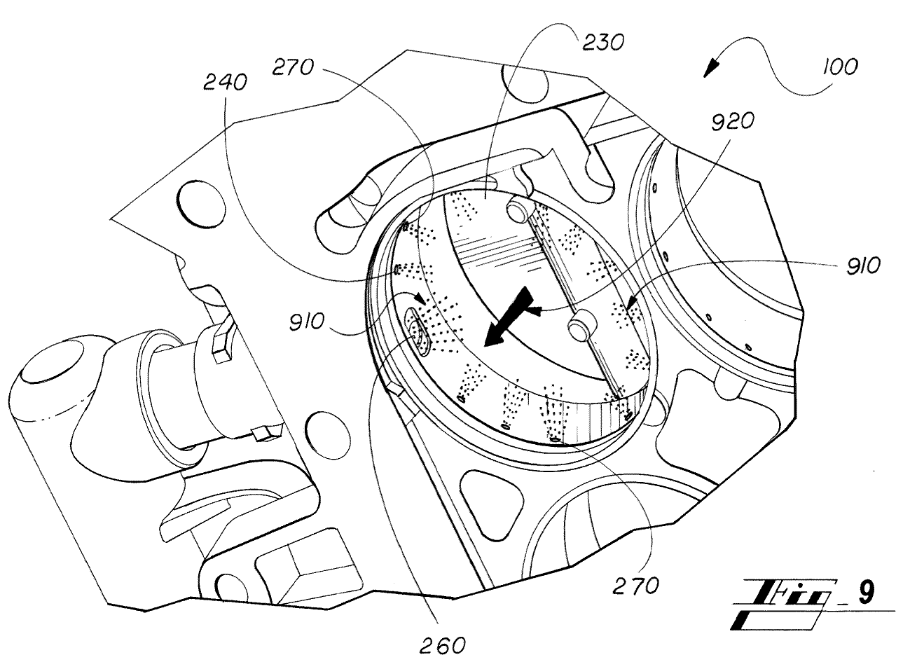

In a preferred embodiment the annular ring 240 includes a 0.28 inch wide by 0.155 inch ovular-slot high primary fuel discharge orifice 260 and thirteen 0.047 inch diameter circular secondary fuel discharge orifices 270 radially spaced at 20-38 degrees apart from adjacent orifices, and centered on the primary fuel discharge orifice 260, as shown in FIG. 8.

It will be appreciated by those skilled in the art that the primary fuel discharge orifice 260 and the secondary fuel discharge orifices 270 may each be a variety of shapes having close to the same orifice opening areas as those described in the various embodiments of the invention.

During operation, air enters the throttle body 100 through an air intake 220. The flow rate of the air through the air intake 220 is regulated by the throttle plate 230, which may be controlled electromechanically by an ECU (not shown), or mechanically. Pressurized fuel flows through a fuel rail 110 and into a fuel injector 120 controlled by the ECU, which regulates the amount of fuel flowing through the fuel port 210 into the air intake 220. As shown in FIG. 9, the fuel flow exits the fuel port 210 a portion of the fuel enters the air flow 920 in the air intake 220 through the primary fuel discharge orifice 260 as atomized fuel 910. The remainder of the fuel enters the annular fuel channel 250 and exits the annular fuel channel 250 through the secondary fuel discharge orifices 270 and enters the air flow 920 in the air intake 220 as atomized fuel 910.

In preferred embodiments of the invention, 40% to 60% of the fuel enters the air intake 220 though the primary fuel discharge orifice 260.

In various embodiments the throttle body 100 may have one or more air intakes 220 with each air intake 220 including a throttle plate 230, a fuel injector 120, and an annular ring 240.

In some embodiments of the throttle body 100, the annular fuel channel 250 may be a part of the throttle body 100 rather than of part of the annular ring 240. In other embodiments the throttle body 100 and annular ring 240 may include complimentary portions of the annular fuel channel 250.

In some embodiments the inner wall air intake 220 may have a larger diameter equal to the outer diameter of the annular ring 240 near the bottom to accommodate the annular ring 240 so the inner wall of the air intake 220 and the annular ring 240 form a smooth continuous surface to aid air flow.

In some embodiments the annular ring 240 may include an annular groove 410 or other means to aid the installing and/or removing the annular ring 240 from the throttle body 100.

In various embodiments the annular ring 240 may be coupled to the throttle body 100 by one or more of a press fit, threads, a friction fit, mechanical fasteners, adhesives, and welds.

In various embodiments the annular ring 240 may be made of aluminum, steel, cast iron, other metals, plastics, composites, or other materials and/or combinations of materials suitable for throttle body applications.

In the preceding specification, various preferred exemplary embodiments have been described with reference to the accompanying drawings. It will, however, be evident that various modifications and changes may be made thereto, and additional exemplary embodiments may be implemented, without departing from the broader scope of the invention as set forth in the claims that follow. The specification and drawings are accordingly to be regarded in an illustrative rather than restrictive sense.

1. A method for fuel injection of an internal combustion engine, comprising the steps of:
providing a throttle body, having an air intake extending vertically through said throttle body from an inlet end toward an outlet end, said air intake having a throttle plate disposed therein, a fuel port receiving an electronic fuel injector which couples to said throttle body at said fuel port, function of said electronic fuel injector being controlled electronically by an electronic control unit;
providing fuel from a fuel rail through said electronic fuel injector, to a fuel channel formed by one or both of an annular ring or an inner wall of said air intake;
atomizing fuel into the air intake from multiple directions a plurality of annularly arranged discharge orifices disposed in said air intake;
mixing said atomized fuel with air moving through said air intake;
controlling mechanically or electromechanically, a position of said throttle plate to regulate the flow of air in the air intake; and
regulating, via the electronic control unit, an amount of fuel provided by the fuel injector.

2. The method of claim 1, providing said plurality of annularly arranged discharge orifices with at least one orifice of a primary size.

3. The method of claim 2, providing said plurality of annularly arranged discharge orifices with at least one orifice of a secondary size.

4. The method of claim 1, providing said plurality of annularly arranged discharge orifices with an orifice shape selected from the group consisting of circular orifice shape, ovular orifice shape, elliptical orifice shape, and polygonal orifice shape.

5. The method of claim 1, providing the plurality of annularly arranged discharge orifices in said inner wall.

6. The method of claim 1, providing the plurality of annularly arranged discharge orifices in said annular ring.

7. The method of claim 1, aligning said electronic fuel injector radially relative to a centerline of said air intake.

8. The method of claim 7, aligning said electronic fuel injector horizontally relative to the throttle body.

9. The method of claim 7, aligning said electronic fuel injector at an angle above or below horizontal relative to said throttle body.

10. The method of claim 1, locating said throttle plate adjacent to said plurality of annularly arranged discharge orifices.

11. The method of claim 1, replacing a mechanical carburetor with said throttle body.

12. The method of claim 1, rotating said throttle plate of said to vary said position of said throttle plate.

13. The method of claim 1, further comprising spacing apart each of said plurality of annularly arranged discharge orifices by an angular separation of between about 20 and 38 degrees.
